(19) United States
(12) Patent Application Publication
(10) Pub. No.: US 2011/0191115 A1
(43) Pub. Date: Aug. 4, 2011

(54) INTEGRATED HEALTH CARE MANAGEMENT SYSTEM

(76) Inventor: ADNAN A. ZALAM, Carmel, IN (US)

(21) Appl. No.: 12/945,762

(22) Filed: Nov. 12, 2010

Related U.S. Application Data
(60) Provisional application No. 61/260,817, filed on Nov. 12, 2009.

(51) Int. Cl. G06Q 50/00; G06Q 10/00

(52) U.S. Cl. 705/2

(57) ABSTRACT

A computer software program is operable to provide an ongoing and supported care coordination approach in which nurses and physician extenders work to actively link a patient with the best provider of care for the patient's unique condition. The program works with the patient to ensure compliance with physician orders, and assists with appointments, transportation and the delivery of medical services.

The present application claims priority from U.S. provisional patent application Ser. No. 61/260,817, filed on Nov. 12, 2009, entitled “Integrated Health/Care Management System”, which is incorporated by reference herein in its entirety.

### BRIEF DESCRIPTION OF THE DRAWINGS

The invention may be performed in various ways, and, by way of example only, embodiments thereof will now be described, reference being made to the accompanying drawings in which:

FIG. 1 is a block diagram of an integrated care/population management system of the present invention.

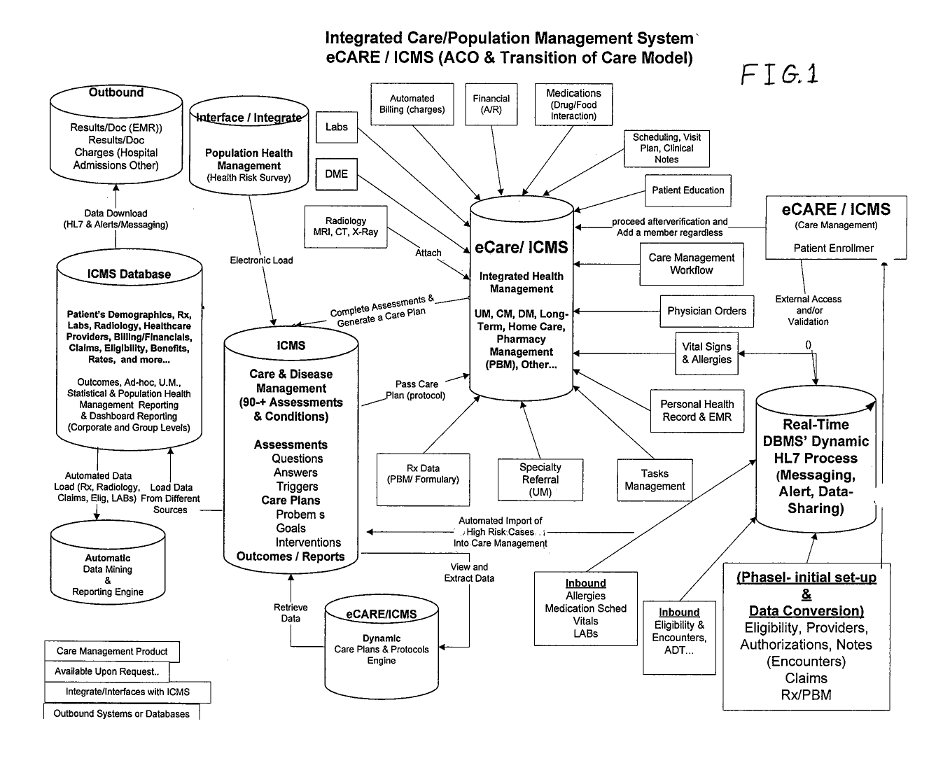

FIG. 2 is a flow chart of a care/treatment plan process of the invention.

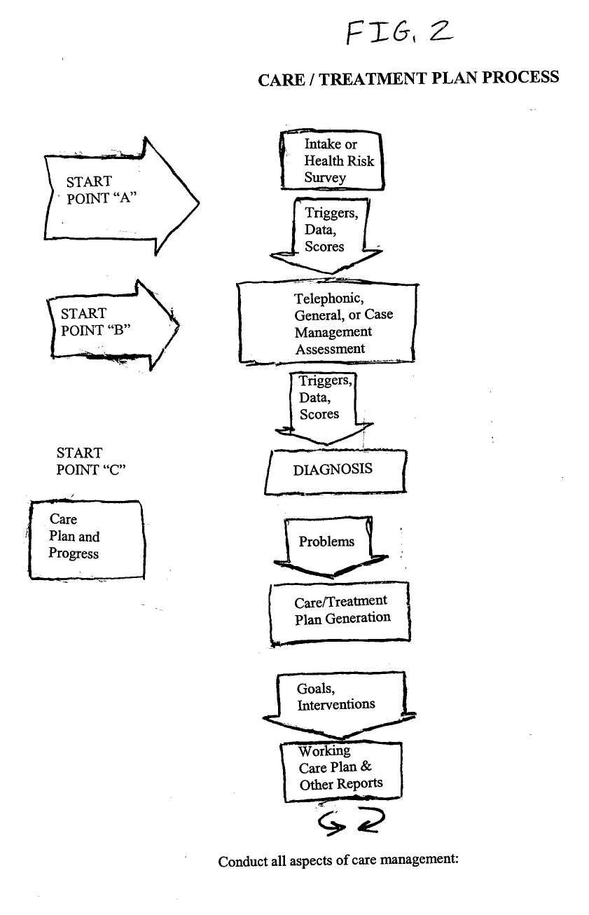

FIG. 3 is a flow chart of a process of the invention.

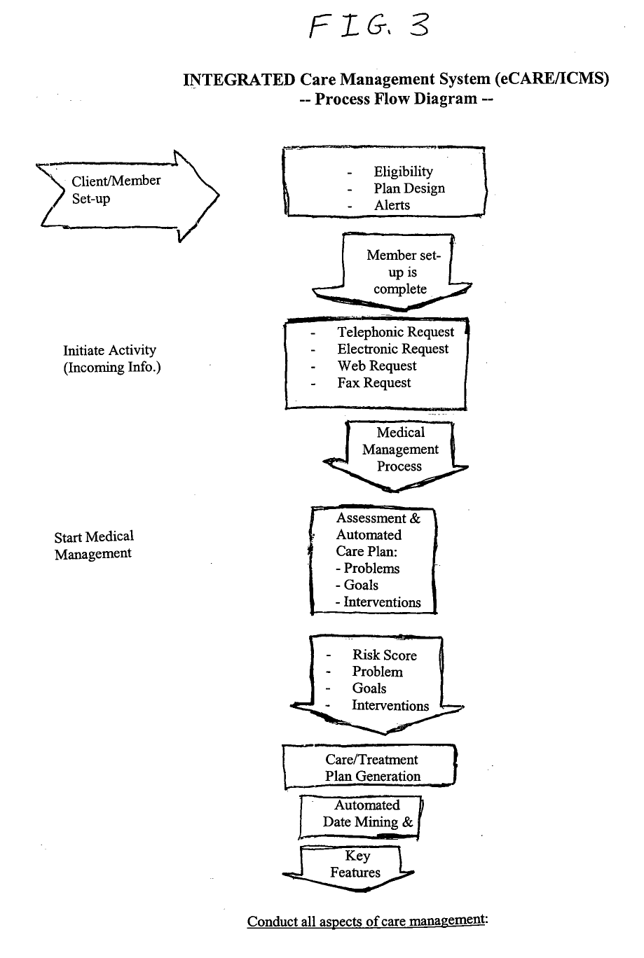

FIG. 4 is an example ICMS care plan report of the invention.

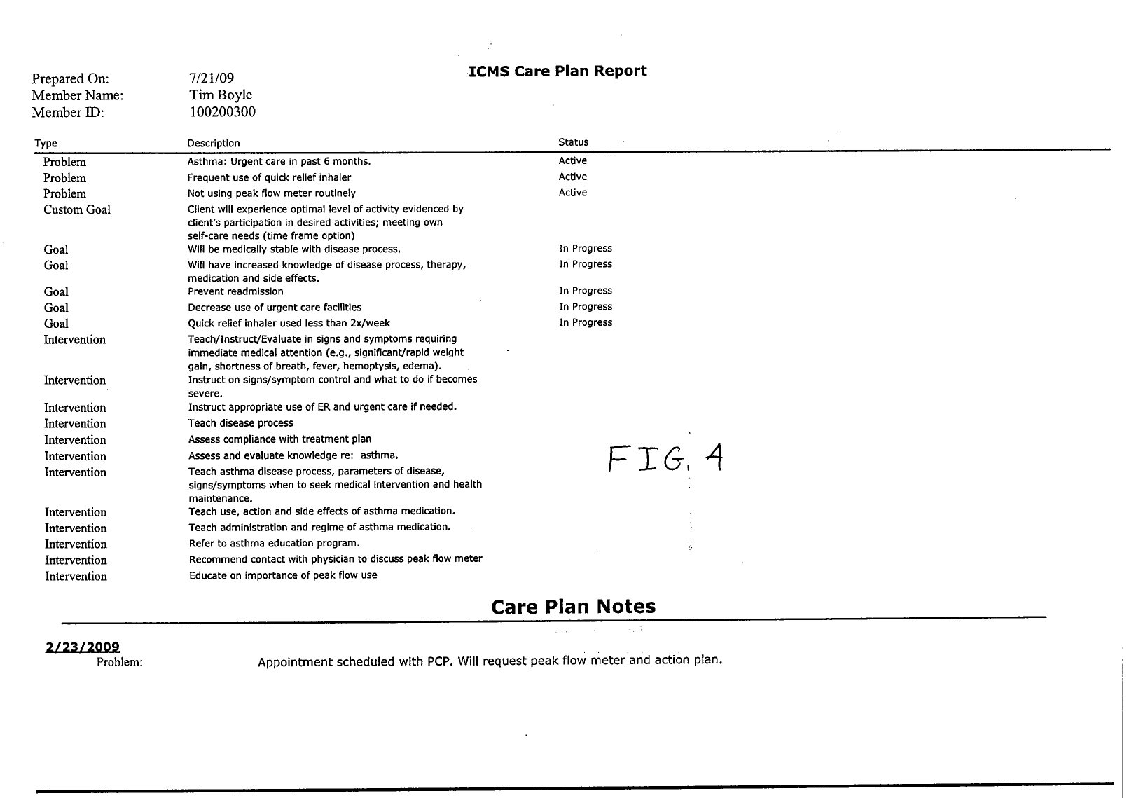

### DESCRIPTION OF THE INVENTION

### High-Level System Implementation & System Overview, Features, and Reports

Utilization Management: —Via our eCARE web base system, Physicians can enter their Referrals and check the status of the Authorization via the WEB. Our UM also accepts Referral Faxes and integrates with RightFax, as well as attach FAX to member's record and parse the Fax, if required. Physicians may also review and edit the POC (Plan of Care) and add Notes as required.
Fully Integration System: Fax Pool, Full UM, Case Management, Disease Management, Care Coordination “Long-Term Care” and Customizable Evidence-Based Plans of Care for over 90 assessments/conditions, as well as full integration of Claims, Rx, and LABS Data.

Integrated Health Management System (eCARE/ICMS)
DBMS' integrated care/health management system includes ALL aspects of care management functions. Users can easily navigate through any of the following functions by directly accessing: Population Health Management, and Clinical Data Reporting.

Key System Features
Member/Patient Enrollment and Administration (Government and Private)
Disease Prevention and Surveillance Alert System: A built-in dynamic engine to identify and monitor Severe Acute Respiratory Syndrome (SARS), Methicillin-Resistant Staphylococcus Aureus (MRSA), Avian Flu, Swine Flu, and more.
Long-term and home care—over 90 assessments and conditions, features, tasks management, visit plan, financial, care plan, laptop/Web access and reporting.
Dashboard (Consolidate Clinical) and ad-hoc reports (by disease condition/globally)
UM (Referral, Authorization) and Automated FAX Referral Assignment/Tracking Workflow
Web-UM & WEB-Reporting Portal: This allows physician offices and other providers to complete their Authorizations via the WEB. The WEB Reporting Portal allows your customers to generate certain reports (real-time).
RN/MD Workflow and Task Management (case assignment, overdue cases, and tracking)
Over 90 Assessments and Chronic Conditions, with automatic stratification and customized “evidence-based” Care/Treatment Plans (Problems/Goals/Interventions)
Patient Registry & Reporting
Clinical Notes & FAX/File Attachments Notes
Identifying and Tracking of High Risk Cases (Automated Member Imports from Medical/RX and ER Claims)
Dynamic capacity to identity Members with, Multiple Admissions and Observations stays via, Specific CPT/ICD9 Codes, etc.)
Dynamic/Ad-hoc Reports Builder, to customize your own reports
Utilization Management, Disease Management, and Pharmacy Reporting
EMR and Personal Health Record (PHR) component which includes: Patient Intake, Medical History, Visit Sheet, Labs, Prescription, Consent Form
Assessment and Protocol Builder (to add, customize, or modify assessment questions/answers), in a short period of time.

### Additional Attributes Include:

Savings based on staffing levels, ease of retrieving information and using the system
Runs on the Web or on a Client Server environment (with secured remote access)
Data Warehouse Solution
Interfaces with Predictive Modeling and HEDIS reporting/systems (customer's choice)
Pharmacy Component used to identify drug interaction, and specialty drugs tracking and reporting)
Pharmacy Management: Control Unit Cost via Medical & Rx. Claims—by tracking J-codes/NDC cross-walks for formulary and specialty drugs, including Misc. Codes* This is a new solution for PBM's.

### Future System Releases:

Population Health Management (Alert System to CDC and City/State Agencies)
Part of our upcoming ICMS release is to add Patterns of Care. Patterns of Care will focus on evaluating the optimal care in regards to a number of chronic conditions. For example, if a patient has congestive heart failure, Patterns will review the system data to see if member/patient is on an ACE Inhibitor, has a cardiologist involved in care, evaluated for routine physician visits, etc. Patterns will then report on the gaps in the patient's care patterns as identified*. ‘*’ Designates an “OPTIONAL” feature (upon request). ICMS will interface with your existing systems

DBMS, Inc. provides Integrated Care Management System, Data Warehousing, and Technical Solutions nationally and internationally. For more information about our company and products, please visit us at www.dbms-inc.com

### PHASE-I System Implementation (Hardware/Software Installation and Training):

### Duration: 3-4 Months

DBMS' product can be installed in your Test then Production environment (under Phase I), based on your business requirements. Our train-the-trainers training sessions will only take three (3) to four (4) business days for each group, which consists of ten (10) users per class.

### PHASE-II System Implementation (Data Conversion & Customization):

### Duration: 3-5 Months

Our recommended “Phase II” implementation will handle any additional customizations, such as Integrating/Interfacing with your Claims system, system changes, report changes, additional reports, data conversion, etc. Enterprise's I/T and the Care Management teams will be involved in the implementation phase.

### Member Info—Member Demographics

Enrollment—DBMS' system will interfaces with your Claims/Eligibility System and allows entry of new members into Care Management, regardless if the member exists in your Eligibility table or not—also based on your requirements.
Laptop Data Transfer—Laptop for field nurses—data check in/out capability available, also available via a web-portal
Case Owner & Tasks Management—Existing and future tasks, over due cases/tasks, tracking, assigning, etc. Also used for productivity reporting.
Security—Users Role, Group, and Network based security (handled by an Administrator User)

### Automatic Stratification Logic/Score:

Disease Management—With a built-in and easy to customize stratification logic score for each disease condition (assessment), e.g. Diabetes, CHF, etc.
Health Risk Survey (HRS or HRA)—Is currently based on the PRA Score, and/or any other method your company wishes to follow.
INTAKE & Case Management Assessment—We also use the same PRA Score in our “short” INTAKE Assessment that triggers the “Detailed” Case Management Assessment. Several companies started to choose the INTAKE because it is based on KEY questions that can quickly determine if the member is “At Risk”; if so the user will then complete the Case Management assessment. Any or all of the above can be used, if required.

### Pharmacy Management—

A Pharmacy Management Data Warehouse (with Web Reporting capability), to control Unit Cost via Medial & Rx. Claims, tracking J-Codes/NDC cross-walks for formulary and specialty drugs, including Misc. Codes resolutions (customizable).
Predictive Modeling—Can be totally integrated in our care management system.

### Standards for Care/Treatment Plan and Guidelines are Based on:

American Medical Association
American Diabetic Association
Nursing Care Plans: Guidelines for individualizing patient care—Doenges
Practical Geriatric Assessment—Fillet
Geriatric Care Plans—Newman
The law of Hospital and Health Care Administration—Southwick
InterQual & Milliman
APPA “American Physical Therapy Association”
AARP Long-Term care plan “American Association of Retired Person”
Other specific standards that the company uses . . .
   Edits: Find or Search, Cut/Paste, Copy, Attached any document or file, create extracts, Fax/Email Reports “securely”, and much more . . .
   Features: Member Search, Physician, care manager by Network, Group, Geographic Location
   Reports (these are mostly used for Long-Term Care and Home Care)—We will demonstrate most of our UM, Case, and Disease Management “Dashboard” reports during our presentation):
Report Builder—Customizable and easy to use reports. All of our reports can be scheduled to run and/or print automatically, if required. Key reports are available via our Web Reporting Portal and Web Services, where applicable.
Ad-Hoc Reports (DBMS will provide an easy-to-use Reporting Database with several key queries to customize and write your own ad-hoc reports); you may also attach some of these reports to the Main Menu Option on your own.
Standard Reports, Geriatrics “Outcome” & Care Plan Reports
Care Coordination—System Features and Reports:
   Health Risk Assessment (Web-based and electronic feed available)
   Assessments (total exceeds 90 assessments, evaluations, and conditions)
   Supplements or Supplemental Assessments
   Disease State Monitoring
   ECB Monitoring
   Secondary Screens
Home Care Management
   Care Plan
   Evaluation Notes
   Assessment to Care Plan Aging
Other Related System Features:
   Care Plan
      Problem Summary
      Complete Care Plan
      Working Care Plan
   Visit Plan
   Disease State Monitoring
      ECB Monitoring Aging Detail
      ECB Monitoring Summary
      ECB Completed
   Health Risk Reports
   Health Risk Aging
   Health Risk
   Health Risk Call Back
   Outstanding Health Risk
   Missing HIC Numbers
   Nursing Home Listing
   Outstanding Data Transfer
   Pharmacy Referral
   Supplement Aging
   To Do List
   Tool (Assessment) Details
   Variance
   Work Load
   Data Entry or Inserts: (Admission, End Period)
   To Do List (on-line and via report—Tracking and Quality)
   Forms—Medical Supplies
   Notes—Evaluation Notes
   Others (available upon request):
   HCFA 485, SF12 & SF36 (DBMS provides limited licenses, if used)
   Active Member
   Assessment (Not Completed, Completed)
      NOTE: DBMS uses in-house Assessment and Protocol Builder. Therefore, DBMS will activate a new or existing assessment or condition within a short period of time; if DBMS doesn't have the new assessment or condition in the system already, DBMS' I/T will design that for you within 3-15 business days, depending on complexity.

### Special Geriatrics Report

### Outcomes & Population Health Management

### From

### DBMS' Care Management Data Repository (CMDR)

### Available Upon Request

| Report | Purpose | Note |
|---|---|---|
| *Comparison of HRS Age 65> | Compare health trends | |
| then age 85> | from year to year to | |
| | determine frailty in | |
| | population | |
| *Chronic Disease report 65> | Review the chronic | |
| then age 85> | diseases compared year | |
| | to year. | |
| *Admission rates to the hospital | Review rates in Year- | |
| separated by SMA providers | 1, 2, 3 | |
| vs. Network providers | | |
| *Assessments completed total | Summary report year to | |
| year to year broken down by | year | |
| Primary, Client, Secondary | | |
| levels | | |
| *Active client case load by | Summary report year to | |
| level chronic and monitoring | year noting trends such as | |
| | increases in monitoring or | |
| | % of total in monitoring | |
| | vs. chronic. | |
| *Chronic Disease including | Summary report year to | |
| comorbidity of 2 or more | year | |
| chronic illnesses (CHF, COPD, | | |
| DM) | | |
| *Active cases compared to | Look at the members that | |
| admission rates | have been in case | |
| | management for at least | |
| | one year compared to | |
| | those not in case | |
| | management | |
| Hospital days & program rate | Trend report year to year | |
| per 1000 | to determine institutional | |
| | impact | |
| SNF days vs. Custodial day | Trend report year to year | |
| rate per 1000 | to determine nursing | |
| | home admission rates | |
| *Extended Care Benefits | Summary report of usage | |
| Transportation | of benefits. | |
| Falls Clinic | | |
| Home Care | | |
| All other benefits | | |
| By age 65> then age 85> | | |
| *Compare ADL information | Summary report year to | |
| from the HRS | year age 65> and 85> | |

Note:
Outcomes, Utilization Management, population health management, and Dashboard reports are available upon request; those reports may require an interface to your Claims, Pharmacy, and/or LABS data.

### Overview:

In addition to the following standard reports, mainly used for Long Term Care and Care Coordination, system users are capable of easily customizing ad-hoc reports and queries via DBMS′Reporting Database.

### Key Reports

1. Active Member Detail (by case/site/network)
2. Assessment or Condition Completed (Details/Summary)
3. Assessment or Condition Details
4. Assessment to Care Plan Aging
5. Care/Treatment Plan Aging (Detail/Summary)
6. Care/Treatment Plan Report (Complete/Problem/Working)
7. Referral & Authorization Letters (Denial, Approval, Etc.)
8. Health Risk Survey
9. Health Risk Workload (create a new report for Intake Assessment)
10. Disease Monitoring
11. ECB Monitoring
12. Weekly Update Report (Status of Participation)
13. Enrollment Health Risk (for the last year)
14. Member Assessment Mailer Report (by site or member)
15. Health Risk Aging
16. Hospice Referral
17. Missing HIC (Medicare #)
18. Nursing Home Listing
19. Pharmacy Referral
20. Supplement Aging
21. Variance
22. Visit Plan
23. Reinsurance Renewal and Medical Management “Savings” Reports
24. And other ad-hoc reports . . .

### Dynamic Ad-Hoc, Quarterly, and Other Reports:

1. Program Participation by Condition
2. New Enrollees by Condition
3. Active & Inactive by Condition
4. Disenrollment Reasons by Program
5. Number of Enrollees (in multiple Health Management Program)
6. Participation Rate, Utilization Management, and Financial Reports
7. Age-Gender Distribution
8. Current Enrollment by Referral Source
9. Current Enrollment by Work Location
10. Risk Stratification Level by Condition
11. Case Management
12. Group Home Member Listing
13. UM Reports
14. UM Dashboard Reports (ER Visits/1000, Visit Visits, Admissions, Rx, gb1c, etc.)
15. Pharmacy Dashboard Reports (Specialty/other drugs, Total Cost Per Month, Avg. Rx per month, PMPM Cost, Rx “Days Written”, Top 10 Drugs, etc.)
16. Pharmacy Management Reports—Control Unit Cost, J-code/NDC Mapping, Misc. Codes, more.
17. Predictive Modeling and HEDIS reports
   Note: Outcomes, Utilization Management, population health management, and Dashboard reports are available upon request; those will require an interface to your Claims, Pharmacy, and/or LABS data.

### DBMS' Integrated Care/Health Management System (ICMS/eCARE)

### Healthcare Challenges and Additional System Features

### To Benefit Managed Care Organizations and Government Programs

### Defining the Need:

1. Healthcare utilization in the commercial population has seen a cost increase on average of greater than 10% over the last five years.
2. This cost increase has been driven by two factors:
   Medical inflation
   Increasing utilization
3. Strategies to reduce utilization have been primarily focused on either reducing hospital length of stay or hospital inpatient avoidance.
4. Strategies to effect reductions in utilization of specialty services have been primarily ineffective.
5. Prospective risk management approaches focused on the identification and management of high-risk patients has a very small implementation footprint.
6. Disease management, with a focus on voluntary participation on the part of the patient or passive behavior modification of physicians has also been ineffective.

### A New Paradigm:

1. Active care coordination, also known as care management, involves patient risk assessment, predictive patient risk identification, the formation of a care plan, referral to specialized care coordinators, and implementation of that patient-specific care plan.
2. The core of the patient management plan is the DBMS Health Services platform.
3. The DBMS Health Services platform provides patient management protocols for patients with one or multiple conditions (over 90 different disease states are available).
4. The system is built in .NET and SQL Server open architecture, and runs on the web and remotely. DBMS Health Services also provides clients with web-portal reporting and electronic notification capabilities.

### Why Does This Work?

1. The system provides an ongoing and supported care coordination approach in which nurses and physician extenders work to actively link a patient with the best provider of care for their unique condition; work with the patient to ensure compliance with physician orders; assist with appointments, transportation and the delivery of medical services.
2. For example, a new patient is identified as having Crohn's disease. A call is made to the patient by the nurse and together they complete a health risk assessment over the phone. This health risk assessment is then used to help coordinate the care for that patient, including helping the patient select the gastroenterologist best capable of handling the situation. The patient is further assigned to a care coordinator familiar with Crohn's Disease who is set up as the patient's “care partner.” This care coordinator then works to ensure compliance with physician orders, assists with lifestyle challenges and management, assists with the coordination of referrals for additional specialty, diagnostic and lab services, and provides ongoing feedback to both the patient and the specialty physician. All of this interaction is managed through the DBMS Health Services system which includes timelines, project management, communication, electronic medical record and claims interface.
3. The integration and accuracy of the data allows for an efficient care coordination process.
4. Care coordinators work closely with the patients, educating them regarding their health condition and promoting an environment of teamwork through which to successfully achieve a healthier lifestyle.

### What's Different?

1. The scope: as opposed to most systems with no more than 9 disease states, DBMS has complete care management protocols for 91 distinct disease states.
2. Fully integrated with the enrollment/claims management system already in place at the TPA/carrier or Health Plan.
3. The system also gathers information from ancillary systems, including the PBM.
4. All of this information, including patient demographics, claims, utilization, and electronic medical record sits in one data repository and is available for data mining and utilization analysis. So you can drill down and see what the problems are for your patient population and devise solutions accordingly.

### Savings:

1. Upon analysis, one employer group of 6,474 employees saved $ 17.14 PEPM on a year-over-year basis. Gross savings constituted medical management savings of $775,000 plus $582,000 savings for disease management.
2. Savings have clustered over 40 disease management areas with a distribution graph as shown in the Disease Education Activity Report (system demo).
3. Savings were generated by care coordination, negotiation of discounts for referral services and reduction of unnecessary or duplicative services.
4. Employer satisfaction, as measured by business retention, is in excess of 90%. Provider satisfaction, as measured both through ongoing review of provider interaction and indirect feedback from clients, is extremely positive, and patient satisfaction remains very high.

### Additional System Features:

### Patient Registry

Managed Care Companies (MCO) continue to struggle with ways to get their Healthcare Effectiveness and Data and Information Set (HEDIS) numbers up and above their competitors. One of the biggest challenges is the ability to track conditions, diseases and preventive health parameters in a cost effective and efficient manner. In many cases MCOs have to pay outside agencies to come in and do this. This not only drives up the MCO's cost, but it also drives up the cost to their clients. Through the use of the ICMS system patient registry feature, MCOs claims, pharmacy and lab data can be linked to the ICMS's patient registry and run routine reports on MCO's entire population or a subset of that population as related to individual employer groups. The patient registry features allows for:
Easy Automation to track data elements tied to prevention and disease monitors.
Integration of demographic information to allow the ease of mailing and/or outreaching a specific population.
Effective HEDIS monitoring that will allow for reduction in cost due to the decrease expense of paying auditors to perform this service.
Effective HEDIS data collection and monitoring that will decrease the need for outside data abstracting.
MCOs to Increase their volume of business without having to add additional staff to perform wellness, diseases and data monitoring.

### Automation of Reports

Reporting timely data and information back to employers, TPA and Brokers is another challenge that MCO's face. There is an enormous demand on the MCO's to provide value added data and reports in a timely manner. MCO's clients constantly ask for data and automated/Web reports in order to:
Track their expenditure.
Prepare for budgeting and unexposed risk.
Verify that the MCO is doing what they said they would.
Track their employees that are given incentives to participate in various wellness programs
Assist with decision on making benefit changes, etc.
   This is an ongoing request that the MCO's are faced with and one of the biggest dissatisfies that occur, due to the MCO's inability to provide information to their clients in a timely manner. Many times the client becomes dissatisfied and decides to move their business. Thorough the use of ICMS the MCO can:
Automate reports for their clients.
Allow clients to schedule their own reports or provide them access to the web-reporting engine
Provide clients access to information that routinely would be difficult for them to capture.
Reduce the number of staff needed for data management and reporting.
Improve client satisfaction with the MCO due to delayed reports and information.
Assist with business underwriting from both the MCO and client perspective.
Use it as a vehicle to assist the MCO's marketing and sales team with customer retention and growth.

### Personal Health Record (Virtual Electronic Health/Medical Record)

Many MCOs are struggling with how to best use a Personal Health record in regards to the population that they serve. In many cases the MCOs have partnered with outside vendors to supply these services, built their own system, or continue to struggle with what they should do and have done nothing to date. What is for certain is that the use of a PHR have been shown to be advantageous, noting that those members that are engage in using a PHR will do better overall in regards to their health. This provides decrease health expenditures to MCO clients and improved client satisfaction with that MCO. Knowing this, the MCO continue to struggle with integrating a Personal Health Record into their services. Through using ICMS MCO's will have access to:
Personal Health Record for all of their members.
A user friendly Personal Health Record design with easy access tabs versus strolling, which will allow for ease of use and decrease frustration and increase engagement.
Ability to auto populate information from claims and pharmacy or lab date into PHR if desire.
Ability to convert to a Virtual EMR/EHR for physicians that would allow for better integration of member information.
Allow the physician as well as the MCO the ability to track data by population. What most physician struggle with is the ability to run data on their patient is order to monitor the services provided. This type of monitoring can be performed through the use of the PHR or Virtual EMR.
Create a medical record or data center that can be used for Hybrid HEDIS testing. This would decrease the MCO from having to send staff or contract labor out to physician offices to collect medical record data.
Aligned themselves with physicians and physician groups by providing the EMR as a service for their contracted physicians to use. It can be sold to the physician at a minimal rate or provided as a value added services with the understanding of knowing the benefits for having such an intergraded data collection tool.
Decrease expense, improve quality of reporting, and better healthcare outcomes by having the above capabilities in place.

### Surveillance and Population Monitoring

The ICMS system has a built-in dynamic engine with the ability to monitor Severe Acute Respiratory Syndrome (SARS) and is in the process of adding Methicillin-resistant Staphylococcus Aureus (MRSA) and Avian Flu. By having this, MCO's can monitor and integrate data for identification of members with these potential conditions. The MCO's can also use this for internal disease management initiatives or as an adjunct to assist their State agencies with community based initiatives.

### Dashboard Reporting

It has never been as important as today for MCO's and their clients to understand the big picture related to the members. In most cases clients are provided with pages upon pages of reports to review and assimilated. In addition to clients getting frustrated with the time it takes to sort through the information, they usually are frustrated because the information is not placed in a format that could be understood by most. Through using the ICMS dashboard reports clients and MCO's will have:
Easily understood one page report that summarizes claims and pharmacy related cost tied to conditions.
Graphic retranslation of utilization data, by month, quarter, and year.
PMPM cost data.
Top ten drugs utilized by the population, including total cost of top drugs.
Ability to see the month to month trend in the population.
Ability to utilize date to design initiatives to assist with appropriately utilization and disease management program that will bring about cost reduction.
Share and review report with key stakeholder without becoming frustrated.
Use for business underwriting and planning.
   The above are a few of the high level features that DBMS's ICMS system can provide. In addition, ICMS is a fully integrated care management system that can be used by MCO's for:
Care Management, Utilization Management, Disease Management, and related reporting
Appeals and Grievances
Case assignment and tracking
Integration of Claims, Pharmacy/PBM, and LABS data
Electronic attachment of faxes (RightFax), files, notes, and letters
Totally paperless system, with ability to print what is necessary
Web-portal Integration that can be used by MCO's staff and external physicians
Health Risk Assessment and related reports/outcomes
Managing over 90 automated protocols that include assessments/conditions and care plans
Savings Tracker (Hard and Soft)
Integration with HEDIS and Predictive Modeling
Underwriting and reporting to, Underwriters, TPA's, and Brokers

Core Assessments & Disease Conditions
Any of the following disease conditions or assessments may be utilized in the Care Management Process, depending on your business need. The following assessments and disease conditions are used in conjunction with a trigger to further gather information regarding a specific medical condition(s).

| | | |
|---|---|---|
| Arthritis | Depression | Mini Mental |
| (Regular, Medicaid) | | State |
| Asthma | Depression | Patient |
| (Regular, Pediatric) | Scale | Satisfaction |
| Alcohol | Diabetes | Pediatric |
| Back Pain | Elder Abuse/ | |
| | Neglect | |
| Balance | Emphysema | Smoking |
| CAD | Falls | Social |
| | | Relationships |
| Caregiver | Financial | Trouble |
| | | Sleeping |
| Caregiver Behavior | Foot Problems | Vulnerability |
| Caregiver Depression Scale | High Blood | |
| | Pressure | |
| Congestive Heart Failure- | Incontinence | |
| CHF | of Bladder | |
| Caregiver Geriatric | Instrumental | Other Long- |
| Depression | ADL | Term Care & |
| | | More |
| Client Geriatric | Migraine | Episodes of |
| Depression | | Care |

Note:
The above conditions/assessment that are in “bold” are the most used in ICMS.

Health Risk Survey
If required by your business, this can also be utilized as one of the initial steps in the Care Management Process. A specific criteria is used to select potential patients/members for care management services and benefits. The Probability for Re-Admission (PRA) score is categorized as follows (only if applicable to your business, other score methods can be added or customized):
   High Risk—The chances for the patient/member to incur a healthcare event are high. In these events a “Case Management Assessment” may need to be completed.
   Moderate Risk—The chance for the patient/member to incur a healthcare event is moderate. Often, a Care Manager will contact the member via phone and conduct a “Telephonic Assessment” to determine further action.
   Low Risk—The chances for the member/patient to incur a healthcare event are low. In most cases, those members are placed into a Wellness program.
   Note—Any of DBMS' assessment questions and answers can be easily printed and mailed to members/patients, if required.

Disease State Monitoring
If applicable to your business process, this function may apply to patients or members who have been stabilized by Care Coordination interventions and upgraded to a monitoring status. Through built-in automatic triggers (including care and treatment plans), patients who have relapsed and need additional Care Coordination Services will be identified.

| Standalone | Combined Conditions |
|---|---|
| Congestive Heart | CHF/Emphysema |
| Failure (CHF) | |
| Diabetes | CHF/Emphysema/Diabetes |
| Emphysema | CHF/Diabetes |

Secondary Screens
A process for work-up of patients who have “automatically” triggered a special need or have a healthcare event.

| | |
|---|---|
| Durable Medical Equipment | Emergency Room |
| Home Health | Hospitalization |

Extended Care Benefits
A process for work-up of patients who have “automatically” triggered a special need or have a healthcare event.

| | | | |
|---|---|---|---|
| Adult Day | Caregiver | Homemaker | Home |
| Care | Monitoring | | Safety |
| | | | Evaluation |
| Maintenance | Nutritional | One Time | DME |
| Therapy | Supplements | Food | Teaching |
| | | Purchase | |
| Personal | Respite | Situational | Personal |
| Emergency | | Counseling | Care |
| Response | | | Assessment |
| System | | | |

Intake Assessment—A set of few questions to help identify the risk of a member. After completing the Intake, a case manager may decide to use the Case Management Assessment (similar to the Health Risk Survey.)
Case Management Assessment—A more detailed assessment (similar to HRA)
Medicare Managed Care—A targeted assessment for everything covered under Medicare reimbursement and additional medical benefits.
Social Worker Assessment—A targeted assessment concentrating on a patient/member, their living environment, interrelationships (e.g., residence, QOL, caregiver relationships, emotional, financial factors) and/or self-determination of quality of life (MASLOW)
Upon customer's request, the following components can be integrated (or interfaced with) in a future release:
   Predictive Modeling:
   Care management, risk management, financial capabilities, additional reporting, and trending
      Prospective: Prior year information is used to predict future costs
      Concurrent: Expenses that occur during the year of service (used to profile population)
   HEDIS
These are additional conditions/assessments or protocols that can be added to a future system release (available sooner upon request):
   1. Behavioral Health
   2. Hypercholesteremia
   3. Musculoskeletal
   4. Oncology (Breast, Prostrate, Lung)
   5. Renal
   6. Rare Diseases
   7. HIV (Acuity, Assessment, Mode of Transmission)
   8. Breast Cancer (Pedigree)—Done: ready for Web implementation

I claim:

1. A computer software program operable to perform the following computer-implemented steps:
provide an ongoing and supported care coordination approach in which nurses and physician extenders work to actively link a patient with the best provider of care for the patient's unique condition;
work with the patient to ensure compliance with physician orders; and
assist with appointments, transportation and the delivery of medical services.
